(19) United States
(12) Patent Application Publication
(10) Pub. No.: US 2019/0249905 A1
(43) Pub. Date: Aug. 15, 2019

(54) Solar Heat Storage Device

(71) Applicants: Keith V. Pember, II, snowflake, AZ (US); Steven J. Malone, Manti, UT (US)

(72) Inventors: Keith V. Pember, II, snowflake, AZ (US); Steven J. Malone, Manti, UT (US)

(21) Appl. No.: 15/896,058

(22) Filed: Feb. 14, 2018

(51) Int. Cl. F24S 23/74; F24S 20/20; F24S 30/40; F24S 50/20

(52) U.S. Cl. CPC F24S 23/74; F24S 20/20; F24S 2050/25; F24S 50/20; F24S 30/40

(57) ABSTRACT

A solar energy heating system includes a first parabolic reflector and a second parabolic reflector. The first parabolic reflector reflects sunlight into the second parabolic reflector and the second parabolic reflector reflects substantially all of the sunlight through an opening in the first parabolic reflector. A heat transfer system transfers collected solar heat to one or more of a house, a building, a tent, a swimming pool, a steam generator, a radiant heater, a dwelling, a heat storage unit, a thermal battery, or a thermal electric generator.

### BACKGROUND

### Field of the Invention

The present invention is related to solar energy heating devices and solar energy heating storage systems.

### SUMMARY

A solar energy heating system includes a first parabolic reflector and a second parabolic reflector. The first parabolic reflector reflects sunlight into the second parabolic reflector and the second parabolic reflector reflects substantially all of the sunlight through an opening in the first parabolic reflector. A heat transfer system transfers collected solar heat to one or more of a house, a building, a tent, a swimming pool, a steam generator, a radiant heater, a dwelling, a heat storage unit, a thermal battery, or a thermal electric generator.

A first heat exchanger may be attached to the first parabolic reflector. The first heat exchanger may contain material for retaining or storing heat. The solar device may further comprise a second heat exchanger. The second heat exchanger may contain material for retaining or storing heat. The first heat exchanger and the second heat exchanger may be connected by one or more heat transfer lines. The first parabolic reflector may be larger in overall size than the second parabolic reflector. The first solar reflector may track the sunlight resulting in a substantially perpendicular angle of incidence. The solar device may track sunlight using a 2-axis tracking system. The first solar reflector may be attached to a rotating base and two side supports, the rotating base may form a first axis of rotation and the two side supports may form a second axis of rotation. Each axis of rotation may be independently controlled by a first motor and a second motor. The first motor and/or the second motor may rotate to control a temperature within the first heat exchanger. The material for retaining heat may be one or more of: water, brick, metal, metal micro-beads, ceramic, or material with a density greater than 0.9. The second heat exchanger may be a swimming pool. Supplemental electrical heating elements may be positioned near or adjacent to the first heat exchanger or the second heat exchanger. The solar device may provide heat to a home, office, or commercial building. The solar device may further comprise a shutter between the first parabolic reflector and the first heat exchanger. The solar device may further comprise an optically transparent element behind, inside, or near the opening in the first parabolic reflector. The first heat exchanger may be positioned on top of the second heat exchanger. The rotating base may be position on top of the second heat exchanger.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a solar energy heating system in accordance with an embodiment of the invention;

FIG. 2 shows a solar energy heating system in accordance with an embodiment of the invention;

FIG. 3 shows a solar energy heating system in accordance with an embodiment of the invention;

FIG. 4 shows a solar energy heating system in accordance with an embodiment of the invention;

FIG. 5 shows a solar energy heating system in accordance with an embodiment of the invention;

FIG. 6 shows a solar energy heating system in accordance with an embodiment of the invention;

FIG. 7 shows a solar energy heating system in accordance with an embodiment of the invention;

FIG. 8 shows a solar energy heating system in accordance with an embodiment of the invention;

FIG. 9 shows rotating members of a solar energy heating system in accordance with an embodiment of the invention;

FIG. 10 shows a solar energy heating system application in accordance with an embodiment of the invention; and

FIG. 11 shows a solar energy heating system application in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings.

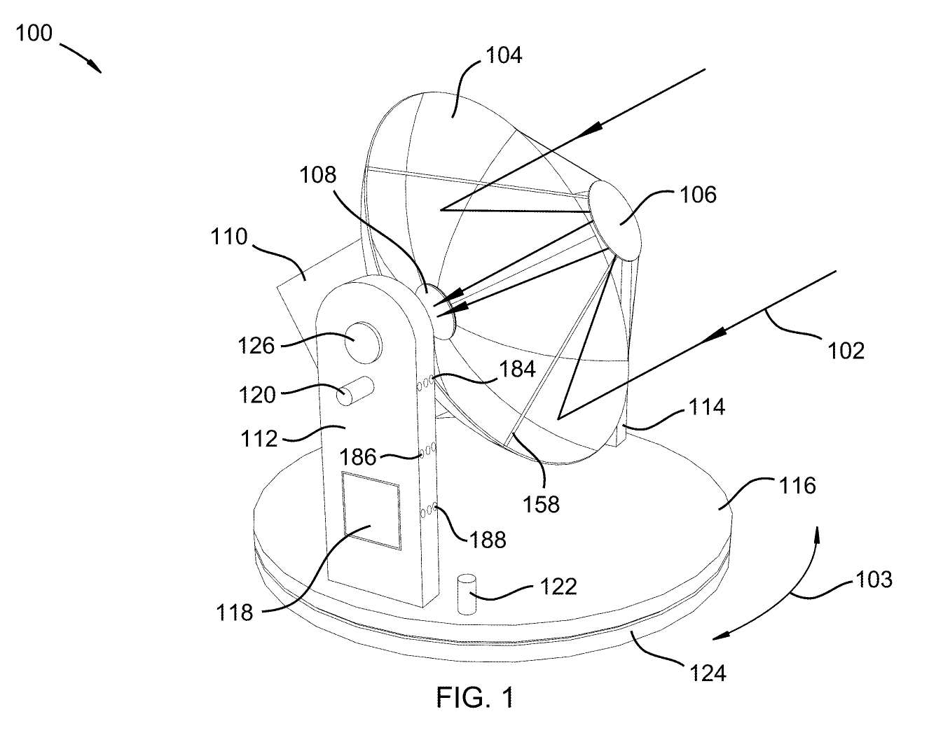

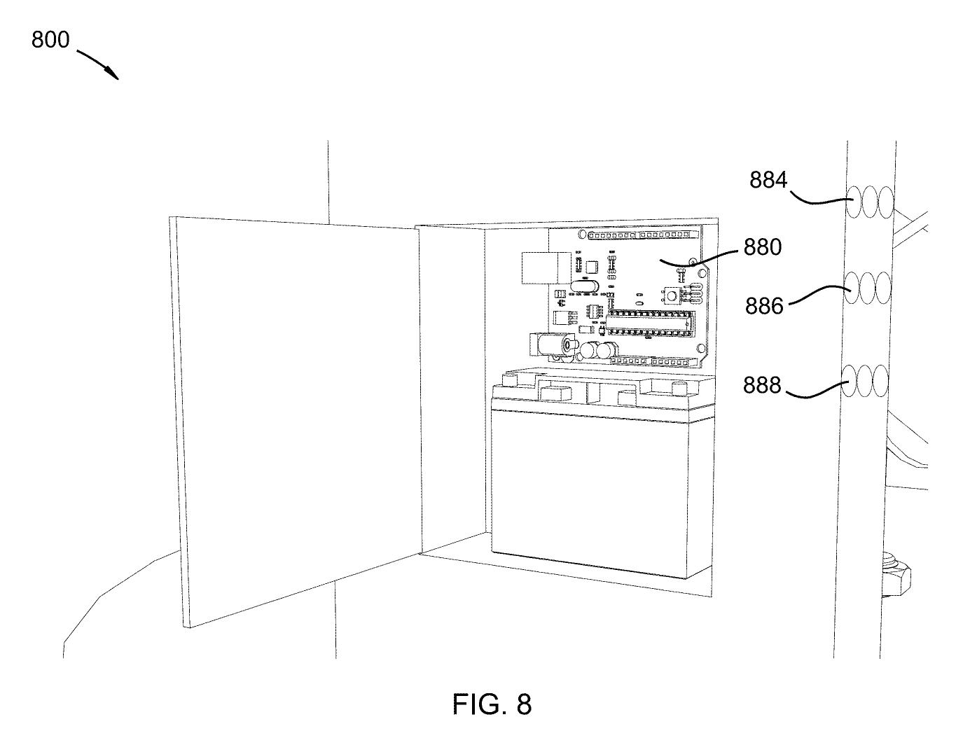

FIG. 1 shows a solar energy heating system 100 including first parabolic reflector 104, second parabolic reflector 106, first heat exchanger 110, first rotational axis 103, electrical control center 118, optical sensors 184, photovoltaic cells 186/188, motors 120/122, top base plate 116, bottom base plate 124, side supports 112/114, rotational pivot 126, incident sunlight 102, aperture 108, and supports 158. Sunlight 102 is reflected off of first parabolic reflector 104 into second parabolic reflector 106 at or near a focal point of first parabolic reflector 104. It may be beneficial to position second parabolic reflector 106 behind or in front of an exact focal point of parabolic reflector 104 to keep second parabolic reflector 106 from overheating. Second parabolic reflector 106 reflects substantially all of the reflected energy through aperture 108. Aperture 108 may be larger than a beam size of energy reflected in order to protect surfaces of first parabolic reflector 104. First heat exchanger 110 may be directly connected to first parabolic reflector 104 or may be remote or removed by a designed gap. Top base plate 116 rotates in relation to bottom base plate 124. Motor 122 may provide force necessary to or rotate top plate 116. Bearings and gearing may be found between top plate 116 and bottom plate 124. Sensors 184 may detect an angular position of the sun based on intensity readings of an array of sensors 184, 186, 188 or by one or more of the sensors of the array. Electrical control center 118 includes a rechargeable battery 882 (FIG. 8), and control circuitry 880. Electrical control center 118 provides motor control for motors 120 and 122. Photovoltaic cells 186/188 provide energy to charge battery 882 and may also be used as an intensity input for determining an angular position of the sun relative to the first parabolic reflector 104. Side supports 112/114 provide structural support for the first and second parabolic reflectors 104/106. Rotational pivot 126 allows first parabolic reflector 104 to rotate in a vertical motion while rotational axis allows first parabolic reflector 104 to rotate in a horizontal direction. Control center circuit board 118 includes motor control drivers, logic programming, analog temperature inputs, analog light intensity inputs, temperature control algorithms, digital inputs, computer programming, memory, and safety circuitry allowing for safe temperature and motion control systems. System 200 is compatible with smart thermostats.

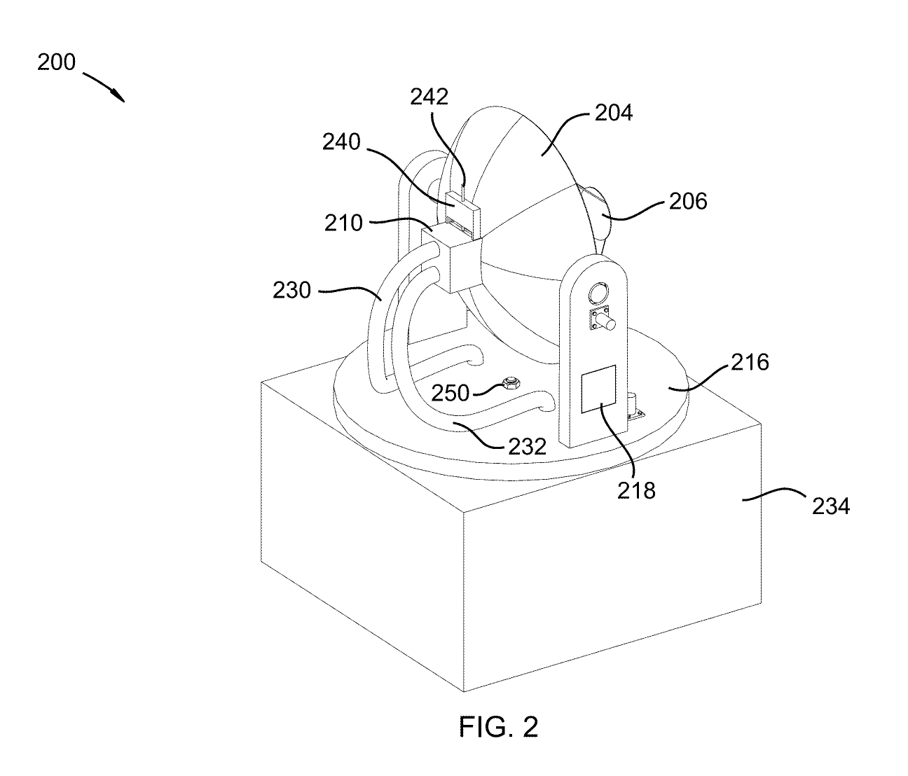

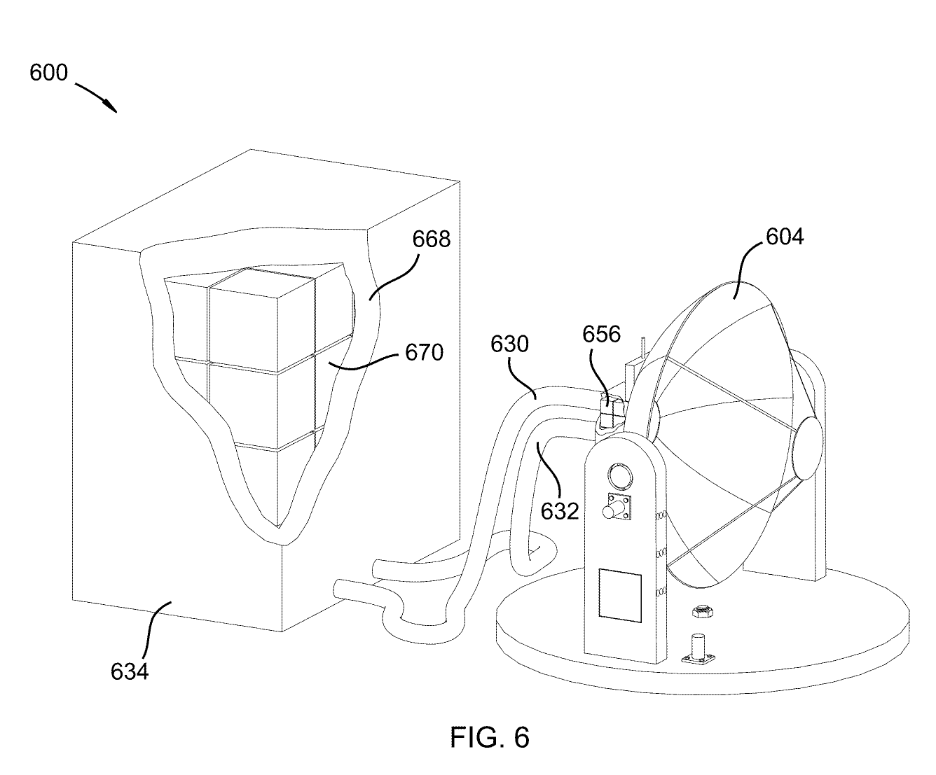

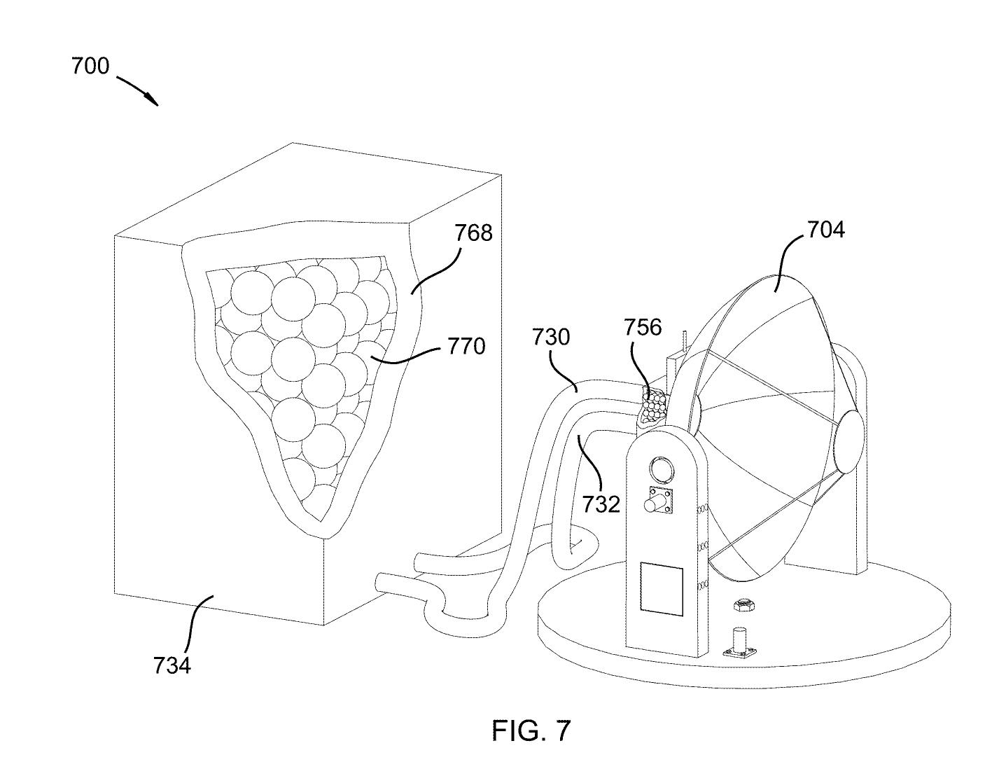

FIG. 2 shows a solar energy heating system 200 including shutter housing 240, shutter actuator rod 242, heat transfer lines 230/232, first parabolic reflector 204, second parabolic reflector 206, first heat exchanger 210, second heat exchanger 234, and fastener 250. Shutter rod 242 may be used to control heat inside of first heat exchanger 210 and/or the second heat exchange 234. Control system 218 may receive temperature readings from temperature sensors associated with first heat exchanger 210 and second heat exchanger 234 and may open or close shutter rod 242 causing light energy to be reflected out and away from both of first heat exchanger 210 and second heat exchanger 234. Another method of controlling heat may be to rotate the first parabolic reflector away from incident sunlight. A fan, blower, or pump may be located within the second heat exchanger 234 to provide movement of fluids through the first and second heat exchangers by way of heat transfer lines 230/232. Second heat exchanger 234 may be insulated heat storage and may be filled with heat retaining materials having a density greater than 0.9. Such materials are described in more detail in relation to FIGS. 6 and 7.

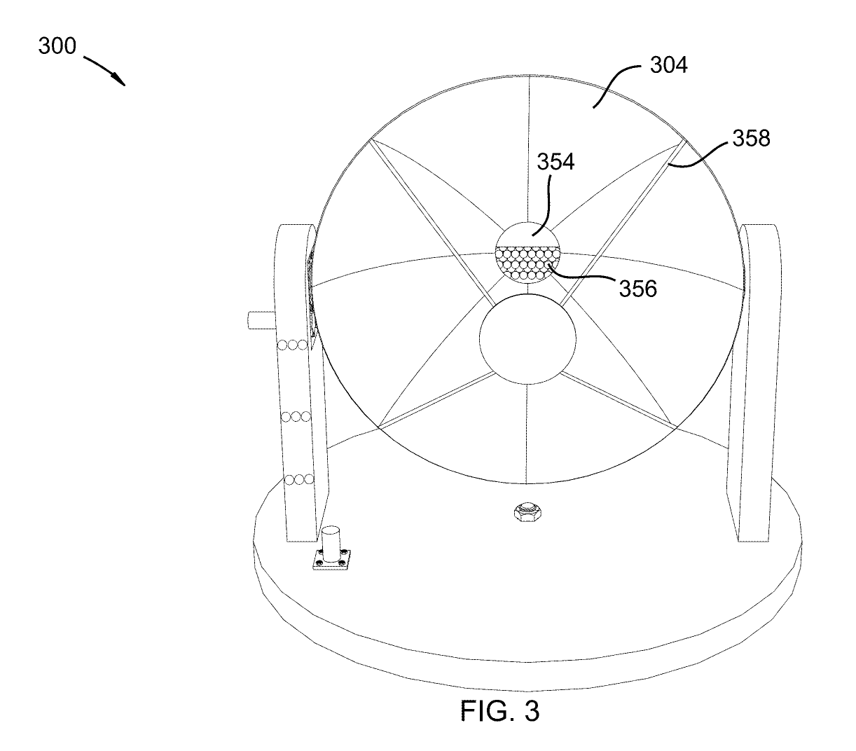

FIG. 3 shows a solar energy heating system 300 including first parabolic reflector 304, second parabolic reflector 306, shutter 354, and heat retaining materials 356. Heat retaining materials 356 may be water, brick, metal, metal micro-beads, ceramic, material with a density greater than 0.9, or any combination thereof. Heat retaining materials 356 may be found inside of first heat exchangers 110/210. An optical lens, or other optical element such as a diffuser, cover glass, or optically transparent material may be positioned as an optical cover allowing light energy to penetrate into first heat exchangers 110/210. Heat exchangers 110/210 may be direct contact heat exchangers directly heating a heat transfer fluid in addition to heating heat retaining materials 356. Heat transfer fluids such as forced air, water, glycol, etc. may be used to remove heat from heat transfer materials 356 and move the heat to another location.

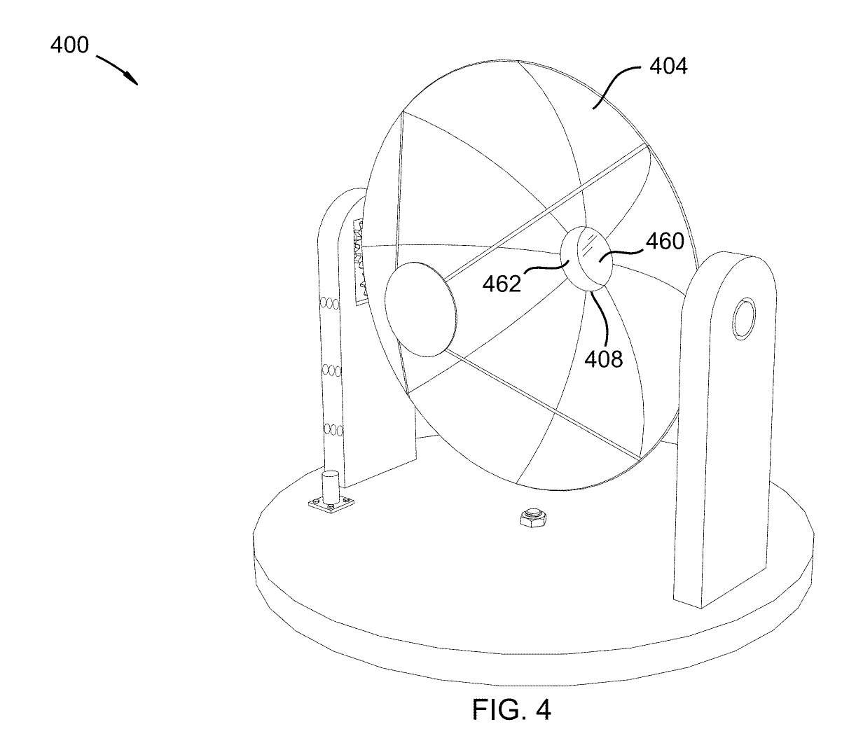

FIG. 4 shows a solar energy heating system 400 including optical element 460 aperture 408 and gap 462. Gap 462 allows a shutter to be positioned between optical element 460 and aperture 408 of first parabolic reflector 404.

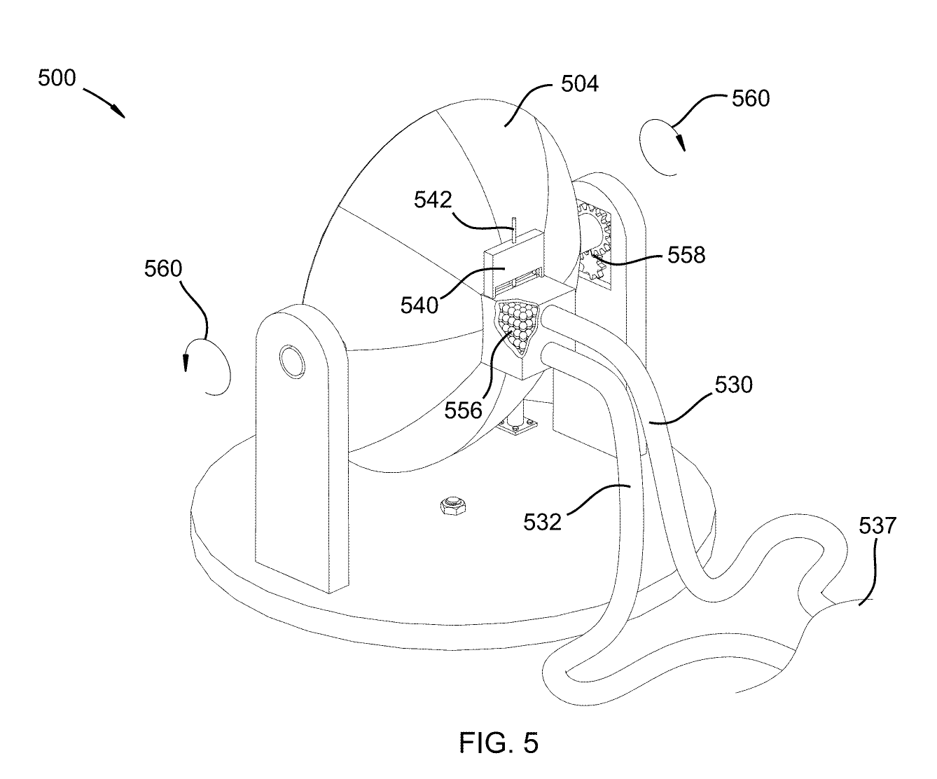

FIG. 5 shows a solar energy heating system 500 including shutter housing 540, shutter actuator rod 542, heat transfer lines 530/532, first parabolic reflector 504. Heat retaining materials 556 may be water, brick, metal, metal micro-beads, ceramic, material with a density greater than 0.9, or any combination thereof. Heat retaining materials 556 may be found inside of first heat exchangers and second heat exchangers. Shutter rod 542 may be used to control heat inside of first heat exchanger and/or the second heat exchanger 537. Another method of controlling heat may be to rotate the first parabolic reflector away from incident sunlight in a vertical rotation 560 or a horizontal rotation by the base. Heat transfer fluids such as forced air, water, glycol, etc. may be used to remove heat from heat transfer materials 556 and move the heat to another location by way of heat transfer lines 532/530. A fan, blower, or pump may be located within the second remote heat exchanger 537 to provide movement of fluids through the first and second heat exchangers by way of heat transfer lines 530/532.

FIG. 6 shows a solar energy heating system 600 with a remote second heat exchanger 634. Heat exchanger 634 may have a high insulation value 668 allowing heat to be stored with low heat loss for days and weeks. Heat retaining materials 670 may be water, brick, metal, metal micro-beads, ceramic, material with a density greater than 0.9, or any combination thereof. Heat retaining materials 670 may be found inside of first heat exchangers 656 and second heat exchangers 634. Second heat exchanger 634 may be remotely located within a forced air furnace and have open air ducts in a top and bottom allowing forced air from a furnace to transfer stored heat in heat retaining materials 670. Sidewall 668 may be located within a furnace or heater or may be part of the furnace or heater itself. Heat transfer lines 630 and 632 may transfer heat from first heat exchanger 656 by way of liquids or gas. Second heat exchanger 634 may additionally include electric heating elements within an inside area 670 allowing electricity to provide supplemental and/or primary heat to second heat exchanger 634. A fan, blower, or pump may be located within the second remote heat exchanger 634 to provide movement of fluids through the first and second heat exchangers by way of heat transfer lines 630/632.

FIG. 7 shows a solar energy heating system 700 with a remote second heat exchanger 734. Heat exchanger 734 may have a high insulation value 768 allowing heat to be stored with low heat loss for days and weeks. Heat retaining materials 770 may be water, brick, metal, metal micro-beads, ceramic, material with a density greater than 0.9, or any combination thereof. Heat retaining materials 770 may be found inside of first heat exchangers 756 and second heat exchangers 734. Second heat exchanger 734 may be remotely located within a forced air furnace and have open air ducts in a top and bottom allowing forced air from a furnace to transfer stored heat in heat retaining materials 770. Sidewall 768 may be located within a furnace or heater or may be part of the furnace or heater itself. Heat transfer lines 730 and 732 may transfer heat from first heat exchanger 756 by way of liquids or gas. Second heat exchanger 734 may additionally include electric heating elements within an inside area 770 allowing electricity to provide supplemental and/or primary heat to second heat exchanger 734. A fan, blower, or pump may be located within the second remote heat exchanger 734 to provide movement of fluids through the first and second heat exchangers by way of heat transfer lines 730/732.

FIG. 8 shows a solar energy heating system control center 800. Control center circuit board 880 includes motor control drivers, logic programming, analog temperature inputs, analog light intensity inputs, temperature control algorithms, digital inputs, computer programming, memory, and safety circuitry allowing for safe temperature and motion control systems.

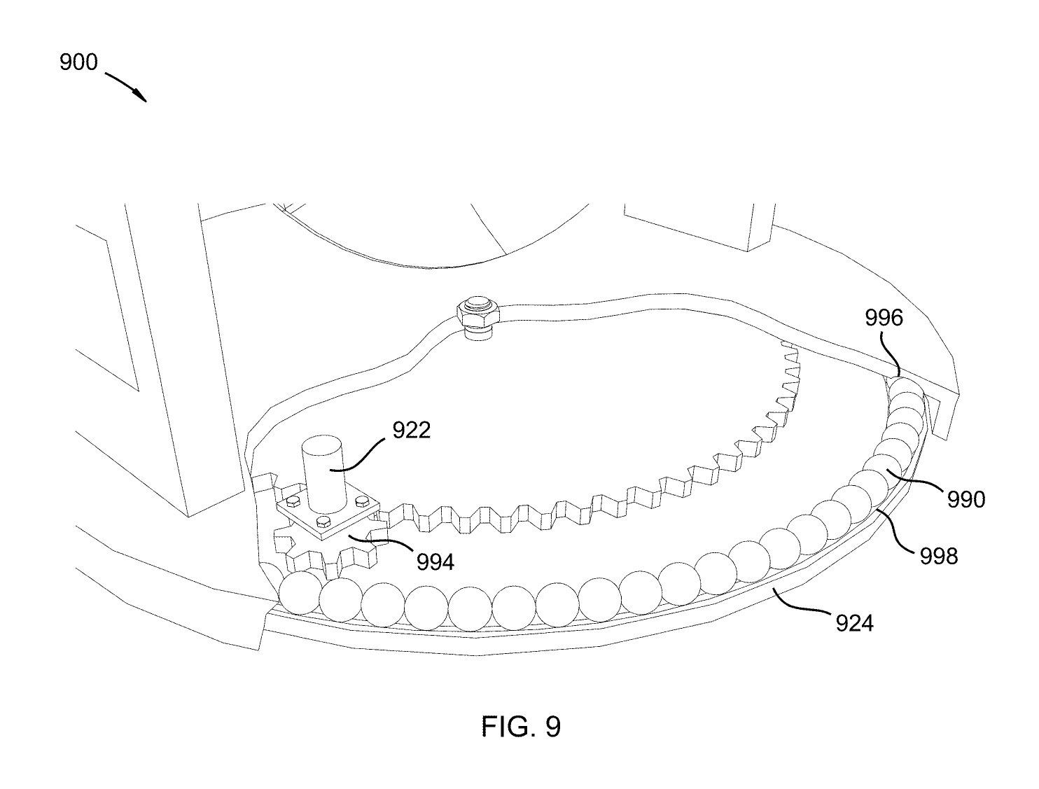

FIG. 9 shows base mechanical motion members 900 including: bearings 990, bottom bearing race 998, top bearing race 996, motor drive gear 994, bottom plate drive gear 992, and top plate 916. Motor 992 is fixed to top plate 916 and rotates with the top plate 916.

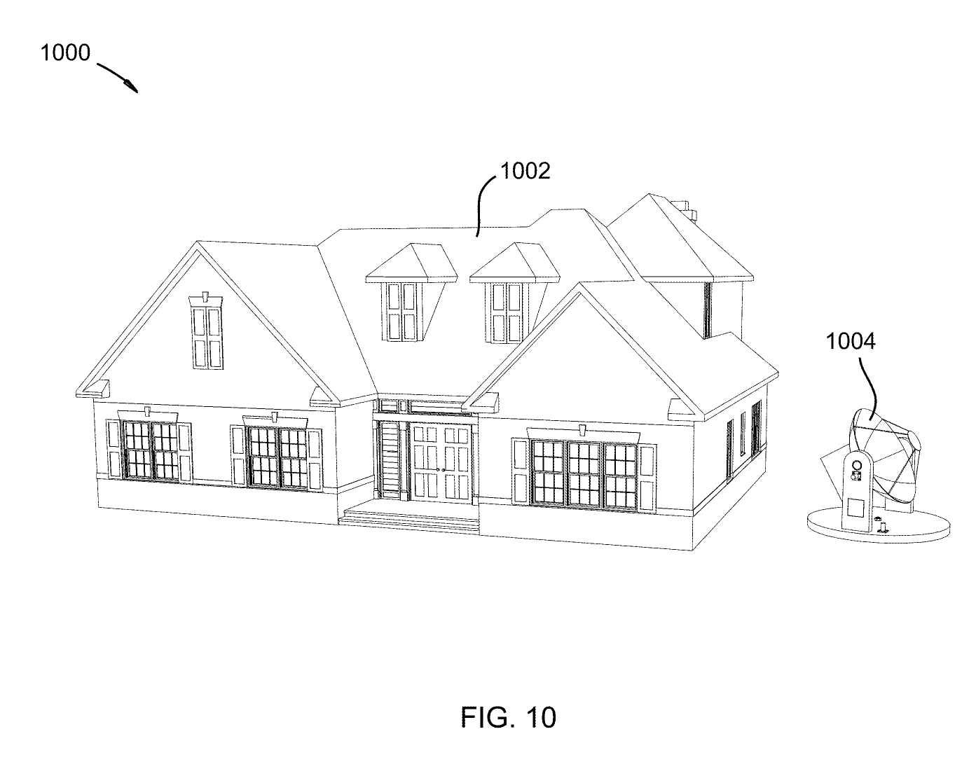

FIG. 10 shows a solar energy heating system application 1000. House 1002 has a second heat exchanger located in a forced air furnace with the home. Heat transfer lines are buried and connect a first heat exchanger of solar heat generator 1004 to the second heat exchanger within the home furnace. During the day solar heat is stored in the home furnace second heat exchanger and my reach temperatures of 1500 F or higher. When the furnace turns on, a small amount of heat may be released allowing heat from the second heat exchanger to warm forced air distributed to the home.

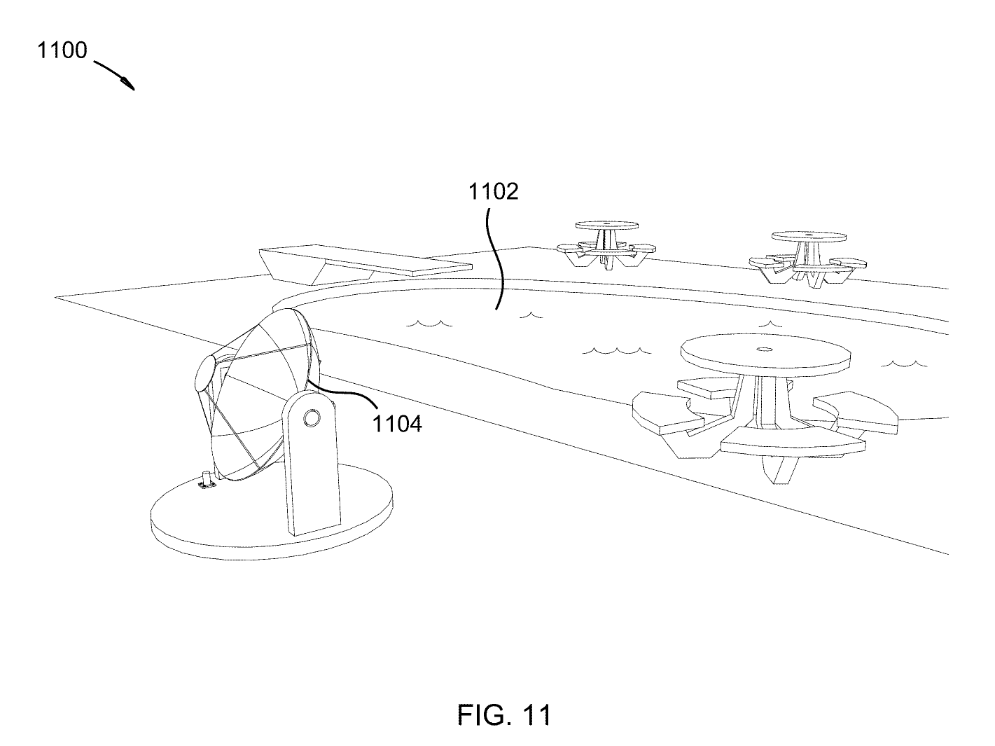

FIG. 11 shows a solar energy heating system application 1100. Swimming pool 1102 is the second heat exchanger. Heat transfer lines are buried and connect a first heat exchanger of solar heat generator 1104 to the second heat exchanger 1102 (pool water). Water may be continuously circulated from the pool 1102 through the first heat exchanger 1104. Other applications may include generation of electricity using a thermal electric module, using a steam generator, or using thermal electric generator. Heat may be mass stored in underground aquifers, underground storage tanks, and in thermal heat containers.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A solar energy heating system comprising:
a first parabolic reflector;
a second parabolic reflector, wherein the first parabolic reflector reflects sunlight into the second parabolic reflector and the second parabolic reflector reflects substantially all of the sunlight through an opening in the first parabolic reflector; and
a heat transfer system which transfers collected solar heat to one or more of a house, a building, a tent, a swimming pool, a steam generator, a radiant heater, a forced air heater, a furnace, a heat storage unit, a thermal battery, or a thermal electric generator.

2. The solar energy heating system of claim 1, further comprising a first heat exchanger attached to the first parabolic reflector.

3. The solar energy heating system of claim 2, wherein the first heat exchanger contains material for retaining or storing heat.

4. The solar energy heating system of claim 2, further comprising a second heat exchanger.

5. The solar energy heating system of claim 4, wherein the second heat exchanger contains material for retaining or storing heat.

6. The solar energy heating system of claim 5, wherein the first heat exchanger and the second heat exchanger are connected by one or more heat transfer lines.

7. The solar energy heating system of claim 1, wherein the first parabolic reflector is larger in overall size than the second parabolic reflector.

8. The solar energy heating system of claim 1, wherein the first solar reflector tracks the sunlight such that a substantially perpendicular angle of incidence is achieved.

9. The solar energy heating system of claim 8, wherein the tracking is 2-axis tracking.

10. The solar energy heating system of claim 1, wherein the first solar reflector is attached to a rotating base and two side supports, the rotating base forming a first axis of rotation and the two side supports forming a second axis of rotation.

11. The solar energy heating system of claim 10, wherein each axis of rotation is independently controlled by a first motor and a second motor.

12. The solar energy heating system of claim 11, wherein the first motor and the second motor are both rotated to control a temperature within the first heat exchanger.

13. The solar energy heating system of claim 5, wherein the material for retaining heat is one or more of: water, brick, metal, metal micro-beads, ceramic, or material with a density greater than 0.9.

14. The solar energy heating system of claim 13, wherein the second heat exchanger is a swimming pool.

15. The solar energy heating system of claim 4, further comprising supplemental electrical heating elements positioned near or adjacent to the first heat exchanger or the second heat exchanger.

16. The solar energy heating system of claim 1, wherein the solar device provides heat to a home, office, or commercial building.

17. The solar energy heating system of claim 2, further comprising a shutter between the first parabolic reflector and the first heat exchanger.

18. The solar energy heating system of claim 2, further comprising an optically transparent element behind, inside, or near the opening in the first parabolic reflector.

19. The solar energy heating system of claim 4, wherein the first heat exchanger is positioned on top of the second heat exchanger.

20. The solar energy heating system of claim 10, wherein the rotating base is positioned on top of the second heat exchanger.
